(19) United States
(12) Patent Application Publication
(10) Pub. No.: US 2010/0031798 A1
(43) Pub. Date: Feb. 11, 2010

(54) Horizontal Band-Saw

(76) Inventor: Vivian WANG, Taichung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/186,597

(22) Filed: Aug. 6, 2008

(51) Int. Cl. B27B 15/02

(52) U.S. Cl. 83/800

(57) ABSTRACT

A horizontal band-saw has a base, a conveyor assembly, multiple band-saw assemblies and multiple auxiliary pressing assemblies. The base has multiple crossbars and multiple stanchions. The conveyor assembly is mounted on the base and has two parallel conveyor belts and a guide panel. The band-saw assemblies are mounted on the base across the conveyor belts and each band-saw assembly has a casing, a drive device, two drive wheels and a band saw. Each casing is mounted on a top of the base and has an adjusting device. Each drive device is mounted on a corresponding casing. The drive wheels are mounted in a corresponding casing. The band saw is mounted around the drive wheels. The auxiliary pressing assemblies are mounted on the base adjacent respectively to the band-saw assemblies and each auxiliary pressing assembly has a front auxiliary assembly and a rear auxiliary assembly.

### BACKGROUND OF THE INVENTION

1. Field of the Invention

The present invention relates to a horizontal band-saw and more particularly to a twin-belt horizontal band-saw that has an improved processing efficiency.

2. Description of Related Art

With reference to FIG. 8, a conventional horizontal band-saw (90) is used to saw an article, such as a wooden board and has a base (91), a conveyor belt (92), a guide panel (93), two auxiliary pressing wheels (94) and a band-saw assembly (95).

The conveyor belt (92) is horizontally mounted in the base (91).

The guide panel (93) is formed on and protrudes from a sidewall of the base (91) near the conveyor belt (92) to abut and guide a side edge of the article.

The auxiliary pressing wheels (94) are connected to the base (91) and extend above the conveyor belt (92), and each auxiliary pressing wheel (94) comprises a resilient element to push the auxiliary pressing wheel (94) against a top surface of the article with a pressing force.

The band-saw assembly (95) is mounted in the base (91) and has two drive wheels (951) and a band saw (952). The drive wheels (951) are rotatably mounted in the base (91). The band saw (952) is mounted around the drive wheels (951) and extends above the conveyor belt (92).

When sawing an article by the conventional horizontal band-saw (90), the article is placed on the conveyor belt (92) and the side edge of the article abuts with the guide panel (93). The auxiliary pressing wheels (94) press on the top face of the article and the article is cut by the band saw (952) of the band-saw assembly (95).

However, the conventional horizontal band-saw (90) only has a single conveyor belt (92) to cut a single article, such that the conventional horizontal band-saw (90) cannot cut multiple articles at the same time in a single procedure and this will decrease the processing efficiency of the conventional horizontal band-saw (90).

In addition, the conventional horizontal band-saw (90) can be adjusted to different sawing positions by moving the conveyor belt (92) up or down relative to the base (91), but the article only can be cut into a particular thickness in a single procedure.

To overcome the shortcomings, the present invention provides a horizontal band-saw to mitigate or obviate the aforementioned problems.

### SUMMARY OF THE INVENTION

The main objective of the invention is to provide a horizontal band-saw that has two belts and an improved processing efficiency.

The horizontal band-saw in accordance with the present invention has a base, a conveyor assembly, multiple band-saw assemblies and multiple auxiliary pressing assemblies. The base has multiple crossbars and multiple stanchions. The conveyor assembly is mounted on a top of the base and has two parallel conveyor belts and a guide panel. The band-saw assemblies are mounted on the top of the base at intervals across the conveyor belts and each band-saw assembly has a casing, a drive device, two drive wheels and a band saw. Each casing is transversally mounted on the top of the base and has an adjusting device. Each drive device is mounted securely on a corresponding casing. The drive wheels are rotatably mounted in a corresponding casing. The band saw is mounted around the drive wheels and extends over the conveyor belts. The auxiliary pressing assemblies are mounted on the base adjacent respectively to the band-saw assemblies and each auxiliary pressing assembly has a front auxiliary assembly and a rear auxiliary assembly.

Other objects, advantages and novel features of the invention will become more apparent from the following detailed description when taken in conjunction with the accompanying drawings.

### BRIEF DESCRIPTION OF THE DRAWINGS

FIG. 1 is a front perspective view of a horizontal band-saw in accordance with the present invention;

FIG. 2 is an operational side view of the horizontal band-saw in FIG. 1;

FIG. 3 is a top view of the horizontal band-saw in FIG. 1;

FIG. 4 is an enlarged front perspective view of the horizontal band-saw in FIG. 1;

FIG. 5 is an enlarged operational side view of the horizontal band-saw in FIG. 1;

FIG. 6 is another enlarged operational side view of the horizontal band-saw in FIG. 1;

FIG. 7 is operational side views of the horizontal band-saw in FIG. 1; and

FIG. 8 is a perspective view of a conventional horizontal band-saw in accordance with the prior art.

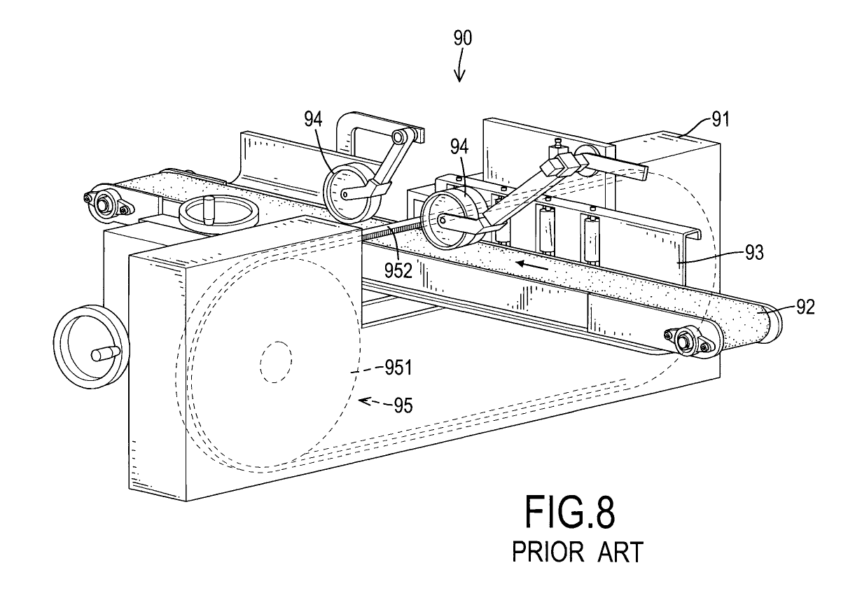

### DETAILED DESCRIPTION OF PREFERRED EMBODIMENT

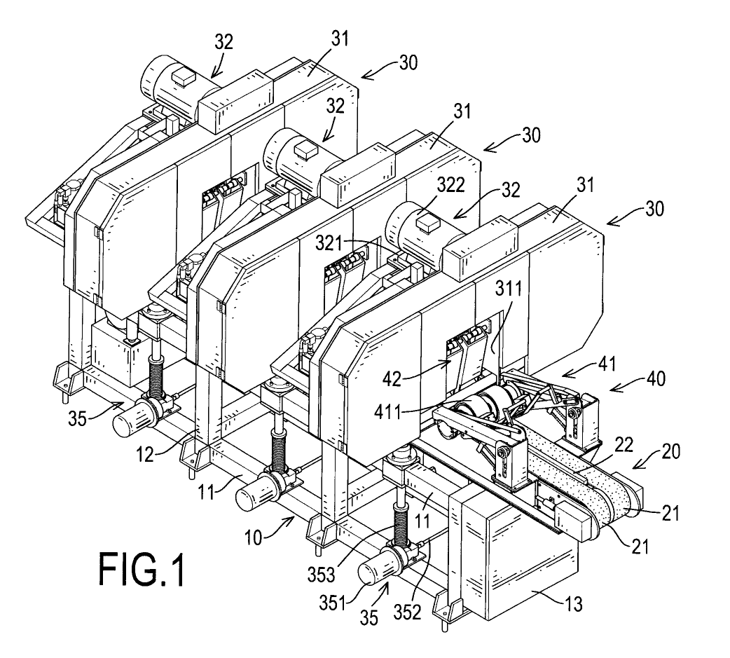

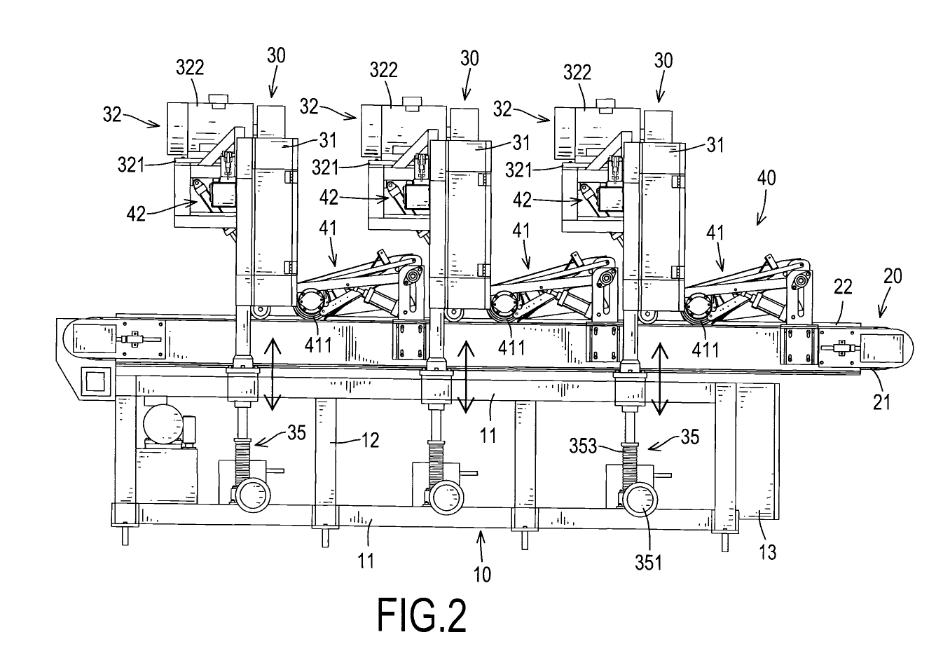

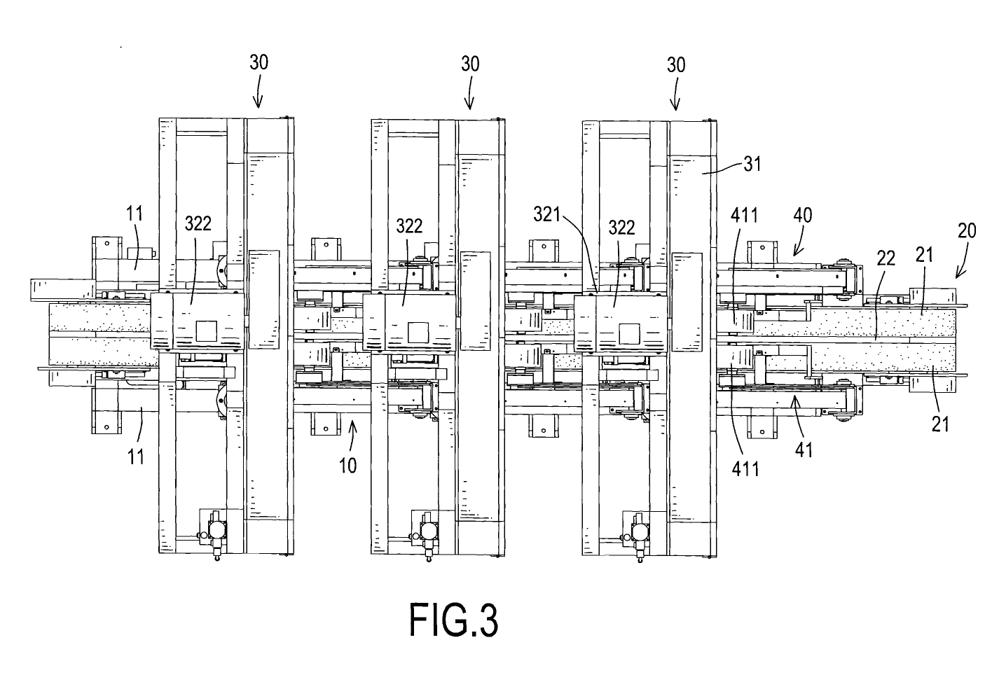

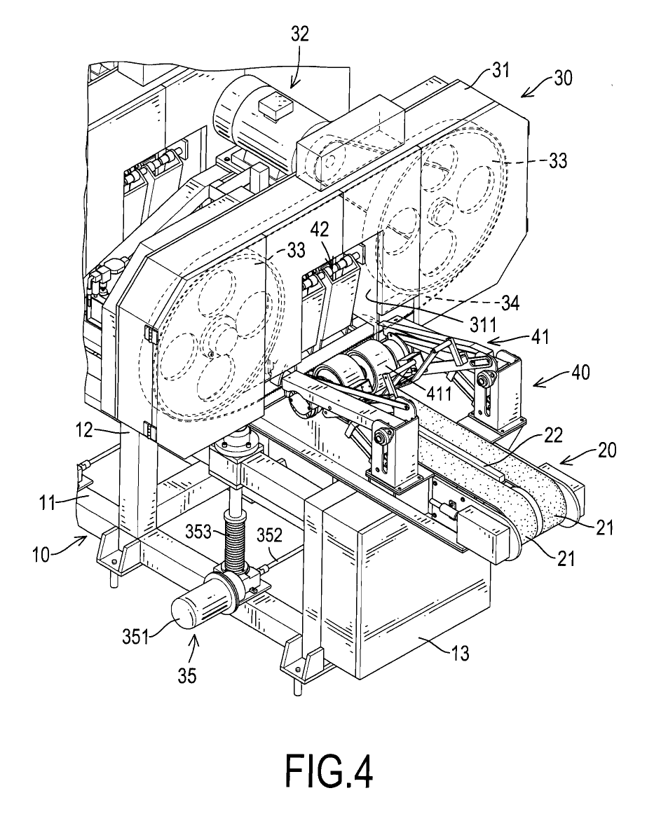

With reference to FIGS. 1 to 5, a horizontal band-saw in accordance with the present invention has a base (10), a conveyor assembly (20), multiple band-saw assemblies (30) and multiple auxiliary pressing assemblies (40).

The base (10) may be rectangular and has a bottom, a front end, a rear end, two sides, multiple crossbars (11), multiple stanchions (12) and a control box (13). Each stanchion (12) is mounted between two different crossbars (11) of the base (10). The control box (13) is mounted in the front end of the base (10).

The conveyor assembly (20) is mounted on the top of the base (10) above the crossbars (11) and has two sidewalls, two conveyor belts (21) and a guide panel (22). The conveyor belts (21) are rotatably and horizontally mounted on the top of the base (10) and parallel to each other. The guide panel (22) is transversely mounted on the top of the base (10) between the conveyor belts (21).

The band-saw assemblies (30) are mounted on the top of the base (10) at even intervals across the conveyor belts (21) of the conveyor assembly (20), may be three band-saw assemblies (30) and each band-saw assembly (30) has a casing (31), a drive device (32), two drive wheels (33) and a band saw (34).

The casing (31) is transversally mounted on the top of the base (10) and has a middle, a bottom, a top, a rear side, an opening (311) and an adjusting device (35). The opening (311) is defined in the middle of the casing (31) near the bottom and corresponds and faces to the conveyor belts (21) of the conveyor assembly (20).

The adjusting device (35) is mounted on the at least four crossbars (11) of the base (10) and is connected to the bottom of the casing (31) to move the casing (31) up or down relative to the base (10) and the conveyor assembly (20) and adjust a cutting height of the band saw (34). The adjusting device (35) has an actuating motor (351), a transmitting shaft (352) and two driving threaded rods (353). The actuating motor (351) is mounted on one of the crossbars (11) in one of the sides of the base (10) below the bottom of the casing (31). The transmitting shaft (352) is connected to the actuating motor (351) at a position below the conveyor assembly (20) and extends to the other side of the base (10) opposite to the actuating motor (351). The driving threaded rods (353) are respectively connected to the actuating motor (351) and the transmitting shaft (352) with transmission device in thread manners, and each driving threaded rod (353) has an upper end. The upper ends of the driving threaded rods (353) are connected to the bottom of the casing (31). Then, the driving threaded rods (353) can be rotated and moved by the actuating motor (351) and the transmitting shaft (352) to make the casing (31) moving up or down relative to the base (10) and the conveyor assembly (20).

The drive device (32) is mounted securely on the casing (31) and has a mounting bracket (321) and a drive motor (322). The mounting bracket (321) is mounted securely on the rear side of the casing (31) and has a top face. The drive motor (322) is mounted securely on the top face of the mounting bracket (321) near the top of the casing (31).

The drive wheels (33) are rotatably mounted in the casing (31) respectively at two sides of the opening (311) and above the conveyor belts (21) of the conveyor assembly (20), and one of the drive wheels (33) is connected to the drive motor (322) of the drive device (32).

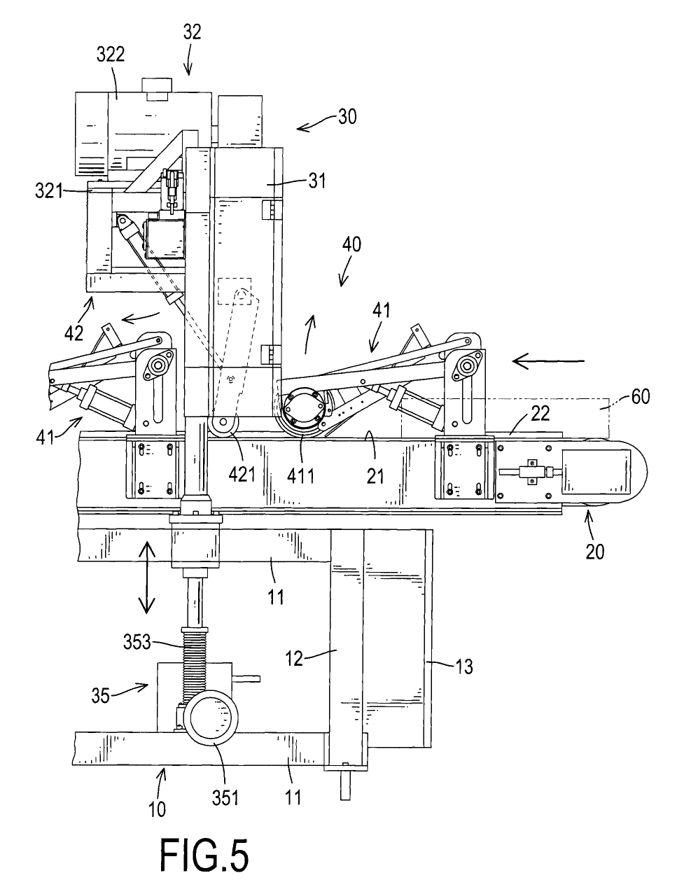

The band saw (34) is mounted around the drive wheels (33) and extends through the opening (311) of the casing (31) over the conveyor belts (21) of the conveyor assembly (20) to saw articles (60) on the conveyor belts (21) as shown in FIG. 5. The position of the band saw (34) relative to the conveyor belts (21) can be adjusted by the adjusting device (35) to provide different sawing dimensions.

The auxiliary pressing assemblies (40) are mounted on the base (10) adjacent respectively to the band-saw assemblies (30), may be three auxiliary pressing assemblies (40) and each auxiliary pressing assembly (40) has a front auxiliary assembly (41) and a rear auxiliary assembly (42).

The front auxiliary assembly (41) is connected to the sidewalls of the conveyor assembly (20) beside the conveyor belts (21) in front of the casing (31) of a corresponding band-saw assembly (30) along a conveying travel of the conveyor belts (21). The front auxiliary assembly (41) has a rear end and two front pressing wheels (411). The front pressing wheels (411) are connected to the rear end of the front auxiliary assembly (41) and respectively located above the conveyor belts (21) to press the tops of the articles (60) respectively on conveyor belts (21) of the conveyor assembly (20).

The rear auxiliary assembly (42) is connected to the casing (31) of the corresponding band-saw assembly (30) below the drive motor (322) of the drive device (32) and has a lower end and two rear pressing wheels (421). The rear pressing wheels (421) are connected to the lower end of the rear auxiliary assembly (41) and respectively located above the conveyor belts (21) near the opening (311) of the corresponding casing (31) to press the tops of the articles (60) on the conveyor assembly (20).

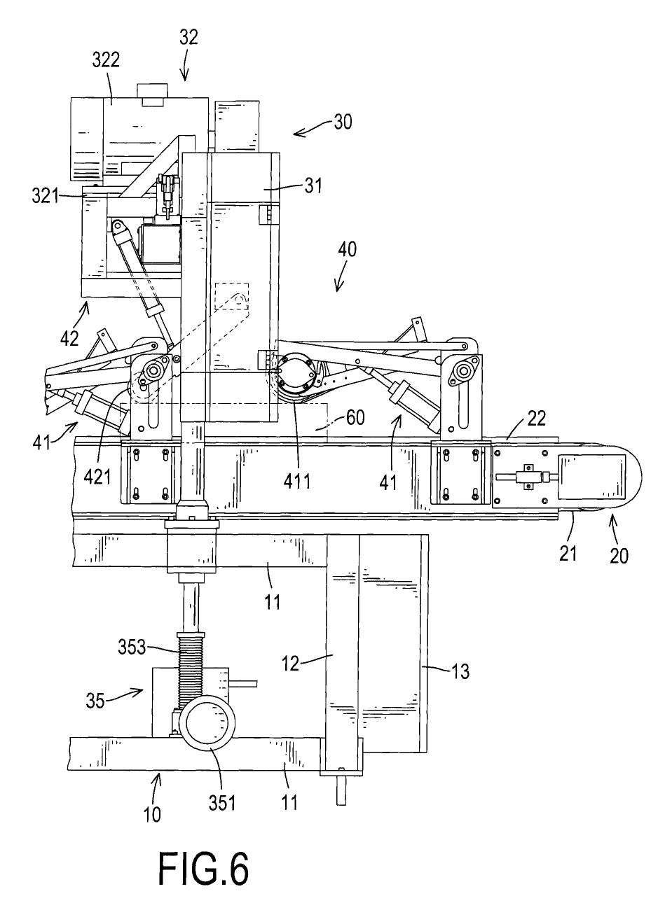

With further reference to FIG. 6, when two articles (60) are respectively put on the conveyor belts (21) and cut by the band saws (34), the pressing wheels (411, 421) of the auxiliary assemblies (41, 42) respectively press on the tops of the articles (60). Then, the articles (60) can be slidably held firmly on the conveyor assembly (20) between the auxiliary pressing assemblies (40).

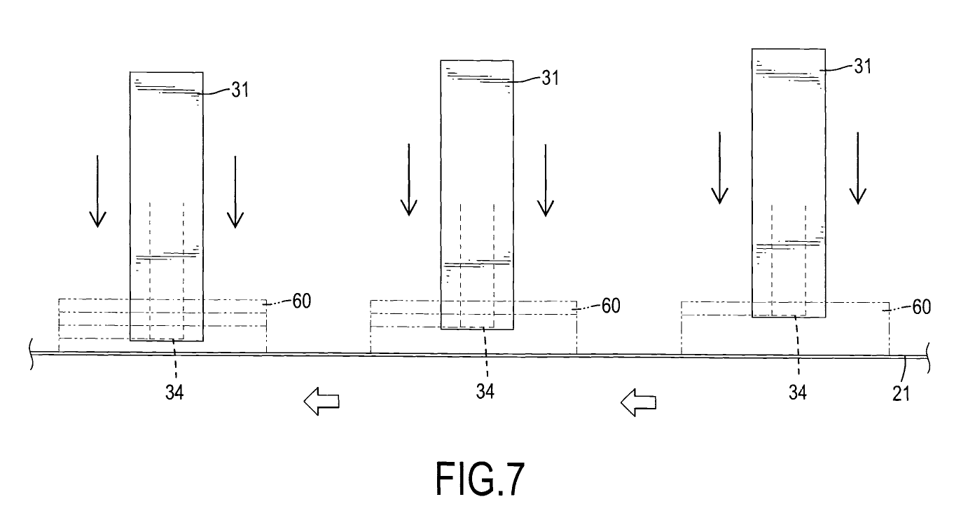

With reference to FIG. 7, when the casings (31) of the band-saw assemblies (30) are moved relative to the base (10) by the adjusting assemblies (35) to locate the band saws (34) at different heights relative to the conveyor belts (21). The articles (60) can be cut with different sawing dimensions in a single procedure into different thickness.

The horizontal band-saw in accordance with the present invention has the following advantages:

1. The horizontal band-saw has two conveyor belts (21), and two articles (60) can be put on the conveyor belts (21) for cutting. Consequently, the horizontal band-saw can cut multiple articles (60) at the same time in a single procedure to improve the processing efficiency of the horizontal band-saw.

2. The band saws (34) of the band-saw assemblies (30) can be adjusted to different positions relative to the conveyor belts (21) by the adjusting devices (35), so the articles (60) can be cut in different sawing dimensions in a single procedure.

3. The pressing wheels (411, 421) of the auxiliary assemblies (41, 42) respectively press on the tops of the articles (60), and the articles (60) can be slidably held firmly on the conveyor assembly (20).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A horizontal band-saw comprising
a base having
a bottom;
a front end;
a rear end;
two sides;
multiple crossbars; and
multiple stanchions being mounted between two of the crossbars of the base;
a conveyor assembly being mounted on the top of the base above the crossbars and having
two sidewalls;
two conveyor belts being rotatably and horizontally mounted on the top of the base and parallel to each other; and
a guide panel being transversely mounted on the top of the base between the conveyor belts;
multiple band-saw assemblies being mounted on the top of the base across the conveyor belts of the conveyor assembly and each band-saw assembly having
a casing being transversally mounted on the top of the base and having
a middle;
a bottom;
a top;
a rear side; and
an adjusting device being mounted on the crossbars of the base, being connected to the bottom of the casing to move the casing up or down relative to the base and the conveyor assembly;
a drive device being mounted on the casing;
two drive wheels being rotatably mounted in the casing above the conveyor belts of the conveyor assembly; and
a band saw being mounted around the drive wheels and extending over the conveyor belts of the conveyor assembly; and
multiple auxiliary pressing assemblies being mounted on the base adjacent respectively to the band-saw assemblies and each auxiliary pressing assembly having
a front auxiliary assembly being connected to the sidewalls of the conveyor assembly; and
a rear auxiliary assembly being connected to the casing of the corresponding band-saw assembly below the drive device.

2. The horizontal band-saw as claimed in claim 1, wherein each adjusting device of the casing has
an actuating motor being mounted on one of the crossbars in one of the sides of the base near the bottom of a corresponding casing;
a transmitting shaft being connected to the actuating motor below the conveyor assembly and extending to the other side of the base opposite to the actuating motor; and
two driving threaded rods being respective connected to the actuating motor and the transmitting shaft and each driving threaded rod having an upper end connected to the bottom of the casing.

3. The horizontal band-saw as claimed in claim 2, wherein
each casing further has an opening being defined in the middle of the casing near the bottom of the casing and between the drive wheels and corresponding and facing to the conveyor belts of the conveyor assembly;
each band saw extending through the opening of a corresponding casing;
each front auxiliary assembly further has
a rear end; and
two front pressing wheels being connected to the rear end of the front auxiliary assembly and respectively located above the conveyor belts; and
each rear auxiliary assembly further has
a lower end; and
two rear pressing wheels being connected to the lower end of the rear auxiliary assembly and respectively located above the conveyor belts near the opening of the corresponding casing.

4. The horizontal band-saw as claimed in claim 3, wherein
the drive device of each band-saw assembly further has
a mounting bracket being mounted securely on the rear side of the casing and having a top face; and
a drive motor being mounted securely on the top face of the mounting bracket near the top of the casing; and
one of the drive wheels being connected to the drive motor of the drive device.

5. The horizontal band-saw as claimed in claim 4, wherein the base is rectangular and further has a control box being mounted in the front end of the base.

6. The horizontal band-saw as claimed in claim 5, wherein the horizontal band-saw has three band-saw assemblies and three auxiliary pressing assemblies mounted on the base.

7. The horizontal band-saw as claimed in claim 1, wherein
each casing further has an opening being defined in the middle of the casing near the bottom of the casing and between the drive wheels and corresponding and facing to the conveyor belts of the conveyor assembly;
each band saw extending through the opening of a corresponding casing;
each front auxiliary assembly further has
a rear end; and
two front pressing wheels being connected to the rear end of the front auxiliary assembly and respectively located above the conveyor belts; and
each rear auxiliary assembly further has
a lower end; and
two rear pressing wheels being connected to the lower end of the rear auxiliary assembly and respectively located above the conveyor belts near the opening of the corresponding casing.

8. The horizontal band-saw as claimed in claim 1, wherein
the drive device of each band-saw assembly further has
a mounting bracket being mounted securely on the rear side of the casing and having a top face; and
a drive motor being mounted securely on the top face of the mounting bracket near the top of the casing; and
one of the drive wheels being connected to the drive motor of the drive device.

9. The horizontal band-saw as claimed in claim 1, wherein the base is rectangular and further has a control box being mounted in the front end of the base.

10. The horizontal band-saw as claimed in claim 1, wherein the horizontal band-saw has three band-saw assemblies and three auxiliary pressing assemblies mounted on the base.
